(19) United States
(12) Patent Application Publication
(10) Pub. No.: US 2006/0225895 A1
(43) Pub. Date: Oct. 12, 2006

(54) Sprinkler system for coverting non-sprinklered buildings

(76) Inventor: William Grant, Chicago, IL (US)

Correspondence Address: SCHIFF HARDIN, LLP;PATENT DEPARTMENT, 6600 SEARS TOWER, CHICAGO, IL, 60606-6473, US

(21) Appl. No.: 11/095,179

(22) Filed: Mar. 31, 2005

(51) Int. Cl. A62C 35/00; A62C 3/00; A62C 2/00

(52) U.S. Cl. 169/16; 169/43; 169/17

(57) ABSTRACT

In the system or method for sprinklering a building, the building has a water delivery pipe for delivery of water to at least two different floors of the building. On at least two floors, a respective sprinkler pipe with a plurality of sprinklers is installed. Also a respective pump is installed whose outlet is connected to the respective sprinkler pipe, and whose inlet is connected to the water delivery pipe. A respective sensor for the respective pump automatically activates the pump when at least one of the sprinklers is activated.

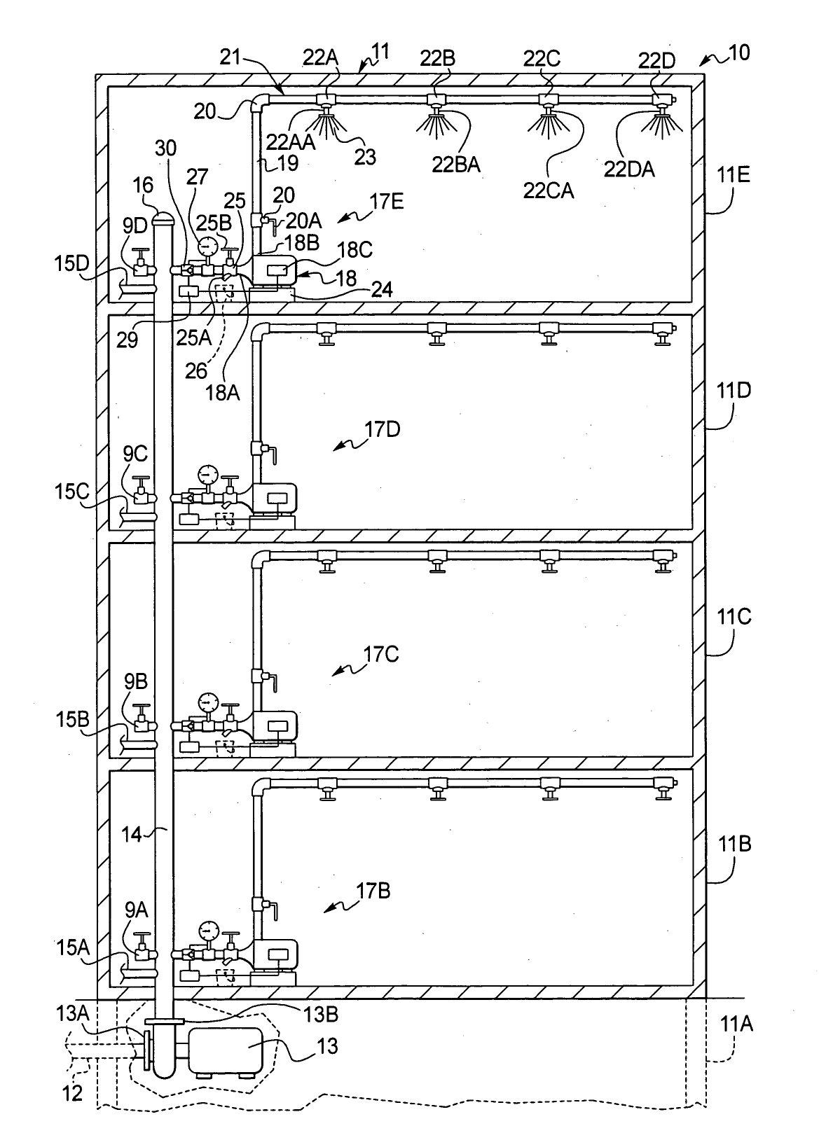

### BACKGROUND

During construction of a multi-story building, it is known to install a sprinkler system for fire protection. A specially designed large volume stand pipe specifically for the sprinkler system runs vertically from the basement of the building up to and through the various floors of the building. The bottom of the stand pipe is connected to an output of a building water pump specifically designed for the sprinkler system. An input of the pump is connected to a water supply pipe to the building. On the various floors, the sprinkler system stand pipe connects through a pipe branching out from the stand pipe to the ceiling sprinkler pipe which has a plurality of sprinkler heads installed thereto.

The building water pump must have sufficient pumping capacity to meet the local building code flow rate requirements—for example at least 22 gallons per minute per sprinkler head for a residential building. Depending on the number of sprinkler heads in the building, the pump and the stand pipe must have sufficient capacity to meet the building code pumping requirement per individual sprinkler head.

In very high buildings, it is also known to provide in addition to a single pump such as in the basement, additional booster pumps in series along the stand pipe at various intervals.

In non-sprinklered buildings, it is known to provide a stand pipe extending vertically through the multi-floor building and providing on each floor a so-called “houseline”—that is an individual fire hose outlet connectable or connected to a fire hose. The previously described booster pumps may also be employed in such a stand pipe with line outlets.

It is also known that in non-sprinklered multi-story buildings, particularly older residential buildings, no water flow type fire protection system at all is provided—that is no stand pipes, no house lines, and no sprinkling systems. In these buildings, all that exists is a domestic water supply pipe extending to the various floors of the building to supply domestic water to restrooms, sinks, or water fountains, for example.

It is very expensive to convert a non-sprinklered building to a sprinklered building after the building has been constructed. A large pump must first be installed such as in the basement of the building, along with a high volume high pressure stand pipe extending up through the various floors. This stand pipe must then be connected by branch-off pipes to the ceiling sprinkler pipes being installed on each floor. This is particularly true in non-sprinklered residential buildings where no stand pipe exists but only the low pressure domestic water pipe. Modification of such buildings is very expensive.

### SUMMARY

It is an object to reduce the expense of installing a sprinkling system in a multi-story building.

In the system or method for sprinklering a building, the building has a water delivery pipe for delivery of water to at least two different floors of the building. On at least two floors, a respective sprinkler pipe with a plurality of sprinklers is installed. Also installing a respective pump is installed whose outlet is connected to the respective sprinkler pipe, and whose inlet is connected to the water delivery pipe. A respective sensor for the respective pump automatically activates the pump when at least one of the sprinklers is activated.

### BRIEF DESCRIPTION OF THE DRAWING

The drawing is a side view of the interior of a building showing a sprinkler system for converting a previously existing non-sprinklered building to a sprinklered building.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

A sprinkler system for converting non-sprinklered buildings is shown in the drawing at 10. A building 11 has, for example, a basement 11A, and first, second, third and fourth floors 11B-11E. Prior to addition of the building sprinkler system of the preferred embodiment, the existing building 11 was fed by a water supply pipe 12, for example connected at an inlet 13A of a water pump 13 typically located in the basement 11A. The existing building water pump 13 has an outlet 13B connected to a stand or domestic water delivery pipe 14 typically proceeding vertically up through the building to deliver water to the various floors of the building via existing floor supply pipes 15A-15D. A cap 16 is provided on top of the pre-existing water delivery pipe 14. If the pre-existing water delivery pipe 14 comprises a stand pipe, then in lieu of, or in addition to, the individual floor supply pipes 15A-15D, pre-existing house lines (fire hoses) may be connected to the stand pipe 14 at house line outlets 9A-9D shown in dashed lines.

For converting the non-sprinklered building 11 to a sprinklered building, the sprinkler system generally shown at 10 is added.

Sprinkler system 10 preferably comprises individual floor sprinkler systems 17B-17E on each floor 11B, 11C, 11D, and 11E. An individual floor system may also be provided in the basement 11A, although not shown.

The individual floor sprinkler systems 17B-17E are preferably respectively provided on each of the floors 11B-11E. Only one of these individual floor sprinkler systems, namely individual floor sprinkler system 17E, will now be described, although the other individual floor sprinkler systems are understood to be substantially the same.

The individual floor sprinkler system 17E comprises a pump 18 having an inlet 18A, outlet 18B, and pressure switch 18C. The outlet 18B connects through a vertical pipe 19 having a shutoff valve 20 with an operating lever 20A inserted in pipe 19. An elbow 20 connects the vertical pipe 19 to a ceiling sprinkler pipe 21 having introduced in series individual sprinkler units 22A-22D, each having respective individual sprinkler heads 22AA-22DA, such as bimetallic sprinkler heads, for example.

The pump 18 may be ¼ to ½ horsepower, for example.

The pump inlet 18A is connected to a test water release valve 25 having a control wheel 25B and a spigot 25A. Beneath the spigot 25A, a bucket 26 may be positioned for receiving discharged water during a test described hereafter.

The valve 25 is connected in series with a pressure sensor such as a gauge 27, which in turn is connected to receive water from the water delivery pipe 14 through a one-way valve 30.

The pressure sensor 27 may output either an electrical or pneumatic signal indicative of pressure. This electrical or pneumatic signal may either be directly connected to the pneumatic or electrical pressure switch 18C of the pump 18 or through an intermediary control unit 29 for converting the pneumatic or electrical signal from the pressure sensor 27 into an appropriate signal for the pressure switch 18C. The control unit 29 may also include a control for a setting an activation level for the pressure switch 18C of the pump 18, for example.

Preferably the pump 18 is mounted on a mounting base 24 to raise its elevation sufficiently to allow placement of the bucket 26 underneath the spigot 25A.

Operation of the sprinkler system which converts the non-sprinklered building into a sprinklered building will now be described.

Initially, it is noted that the pump 18 should have a sufficient pumping power so that in the event of a fire, the local fire regulation pumping water flow rate can be achieved from the individual sprinkler units 22A-22D on floor 11E, for example. If for example, the regulation calls for a flow rate of 22 gallons per minute, a regulation typical for a residential building sprinkler heads, the pump must be sufficiently strong to provide this flow rate from all of the sprinklers in the floor sprinkler pipe. Although only one sprinkler pipe is shown on floors 11B-11E, of course branching additional sprinkler pipes may be employed to provide additional sprinkler pipes with associated sprinkler units.

During normal operation, shutoff valve 20 is open so that pressure is present at the inlet 18A of the pump 18. If a fire occurs on floor 11E, for example, one or more of the sprinkler heads automatically are activated in well-known fashion (for example by a bimetallic valve). This causes a pressure drop measured by pressure sensor 27. This pressure drop is transmitted to the pressure switch 18C of the pump 18 either directly or through control unit 29, thus automatically triggering operation of the pump 18. When the fire is extinguished and the sprinkler heads close, pressure again builds in the floor sprinkler system 17E as measured by the pressure sensor 27 resulting in an automatic shut-off of pump 18.

The one-way valve 30 precludes a back flow of water from the individual floor sprinkler system into the vertical water delivery pipe 14.

To test the system, the shut-off valve 20 is closed and the test water release valve 25 is opened by wheel 25B so that water flows out the spigot 25A into the bucket 26. This causes a pressure drop sensed by the sensor 27 such as a gauge, which then activates the pump 18, indicating that the system is operational.

With the disclosed system for converting a non-sprinklered building to a sprinklered building, substantial cost savings result since the existing stand pipe or domestic water pipe is used for delivery of the water to the individual floors. The existing building water pump 13 does not have to be changed. It is thus not necessary to run a new high-pressure pipeline strictly for the building sprinkler system, since the existing stand pipe or domestic water pipe is employed.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A method for converting an existing non-sprinklered multi-floor building to a sprinklered building, said existing building having an existing water delivery pipe for delivery of water to different floors of the building, comprising the steps of:
on each of at least two of the floors, installing a ceiling sprinkler pipe with a plurality of sprinklers, and also installing a respective pump whose outlet is connected to said respective sprinkler pipe and whose inlet is connected to the existing water delivery pipe; and
for each pump providing a respective sensor which automatically activates the pump when at least one of the sprinklers is activated.

2. A method of claim 1 wherein each of the floors of the building has an individual floor sprinkler system installed therein connected to said existing water delivery pipe.

3. A method of claim 1 wherein said water delivery pipe comprises a previously existing domestic water pipe connected to floor supply pipes for providing water to the individual floors of the building.

4. A method of claim 1 wherein the water delivery pipe comprises an existing stand pipe for delivering water to fire hose outlets on different floors of the building.

5. A method of claim 1 wherein the building comprises a residential building.

6. A method claim 1 wherein the pump has a pressure switch and the sensor comprises a pressure gauge in front of the inlet to the pump so that when a pressure drop is determined by the pressure gauge caused by at least one of the sprinklers discharging water, the pump is automatically activated as a result of a signal from the pressure gauge.

7. A method of claim 1 wherein a shutoff valve is provided between an outlet of the pump and an inlet of the sprinkler pipe and a test water release valve is provided between the water delivery pipe and the inlet of the pump, and to test operation of an individual floor sprinkler system comprising a respective pump and respective sensor, the test water release valve is opened causing a pressure drop which is sensed resulting in a turn-on of the pump.

8. A method of claim 1 wherein the sensor comprises a pressure sensor between the pump and the water delivery pipe.

9. A method for sprinkling a building, said building having a water delivery pipe for delivery of water to at least two different floors of the building, comprising the steps of:
on the at least two floors, installing a respective sprinkler pipe with a plurality of sprinklers;
also installing a respective pump whose outlet is connected to said respective sprinkler pipe and whose inlet is connected to the water delivery pipe; and
also providing a respective sensor for the respective pump which automatically activates the pump when at least one of the sprinklers is activated.

10. A building sprinkler system for converting a non-sprinklered building to a sprinklered building, said non-sprinklered building having an existing water delivery pipe for delivering water to different floors of the building, comprising:
on each of at least two floors of the building desired to be fitted with an individual floor sprinkler system, a pump having an outlet and an inlet;
a sprinkler pipe associated with the pump and having a plurality of sprinklers near a ceiling of the floor;
a pipe connecting the sprinkler pipe to the outlet of the pump;
a pipe connecting the inlet of the pump to the existing water delivery pipe; and
a respective sensor for each pump used to automatically turn on the pump when at least one of the sprinklers is activated.

11. A system of claim 10 wherein all of the floors of the building have said individual floor sprinkler systems installed therein.

12. A system of claim 10 wherein the pump has a pressure switch, a pressure gauge is provided between the pump inlet and the water delivery pipe on the individual floor where the individual floor sprinkler system is installed, and a signal from the pressure gauge triggers operation of the pump via a pressure switch associated with the pump.

13. A system of claim 10 wherein a shut-off valve is provided between an outlet of the pump and the sprinkler pipe and a test water release pipe is provided between an inlet of the pipe and the connection to the water delivery pipe.

14. A system of claim 10 wherein a one-way valve is provided between the inlet of the pump and the connection to the existing water delivery pipe.

15. A system of claim 10 wherein a test water release valve is provided in front of an inlet of the pump positioned at a distance above a floor of the building sufficiently great to permit placement of a bucket for receiving test water when the test water release valve is opened.

16. A system of claim 10 wherein the water delivery pipe comprises an existing stand pipe having outlets for connecting to fire hoses on different floors of the building.

17. A system of claim 10 wherein the water delivery pipe comprises a domestic water pipe connecting to existing floor supply pipes.

18. A system of claim 10 wherein a respective pressure gauge is provided in front of an inlet to the respective pump, a one-way valve is provided between the pressure gauge and the water delivery pipe, a test water pressure valve is provided between the pump inlet and the water delivery pipe, and a shutoff valve is provided between the pump outlet and the respective sprinkler pipe.

19. A building sprinkler system for a building having a water delivery pipe for delivering water to different floors of the building, comprising:
on at least two floors of the building desired to be fitted with an individual floor sprinkler system, a respective pump having an outlet and an inlet;
a respective sprinkler pipe having a plurality of sprinklers;
a pipe connecting the sprinkler pipe to the outlet of the pump;
a respective pump connecting the inlet of the respective pump to the existing water delivery pipe; and
a respective sensor which automatically turns on the respective pump when at least one of the sprinklers is activated.
